(19) United States
(12) Patent Application Publication
(10) Pub. No.: US 2026/0111784 A1
(43) Pub. Date: Apr. 23, 2026

(54) COMPUTING METHOD FOR OBTAINING SLACK VARIABLES IN OBJECTIVE FUNCTION

(71) Applicant: Compal Electronics, Inc., Taipei City (TW)

(72) Inventors: Tsung-Hsuan Tsai, Taipei City (TW); Yi-Ching Chen, Taipei City (TW)

(21) Appl. No.: 18/952,831

(22) Filed: Nov. 19, 2024

(30) Foreign Application Priority Data
Oct. 23, 2024 (TW) 113140412

(51) Int. Cl. G06N 10/60

(52) U.S. Cl. CPC G06N 10/60

(57) ABSTRACT

A computing method for obtaining slack variables in an objective function is applied to a quantum computing device. Through the use of the reinforcement learning method, a first function is obtained. Through the first function, the slack variables solution of the problem's objective function in the QUBO form are found. Consequently, the objective function in the QUBO form is optimized to be used for quantum annealers or digital annealers. Since the number of variables in the objective function is significantly reduced, the complexity of the problem is directly reduced. Furthermore, the annealer has the capability to handle more complex problems and find a high-quality solution more efficiently and accurately. Consequently, the purpose of obtaining the optimal value of the objective function can be achieved.

### CROSS-REFERENCE TO RELATED APPLICATIONS

This application claims priority to Taiwan Patent Application No. 113140412, filed on Oct. 23, 2024. The entire contents of the above-mentioned patent application are incorporated herein by reference for all purposes.

### FIELD OF THE INVENTION

The present disclosure relates to a computing method for obtaining slack variables in an objective function, and more particularly to a computing method for obtaining slack variables in an objective function using the Q-learning algorithm.

### BACKGROUND OF THE INVENTION

In quantum computing applications, the optimization of quantum algorithms and quantum device operations has always been a subject of ongoing research. To utilize annealing machines, the objective function of a problem needs to be transformed into a quadratic equation in the form of binary variables, known as the QUBO (Quadratic Unconstrained Binary Optimization) form. That is, the objective function may be expressed as: objective=Σᵢⱼwᵢⱼxᵢxⱼ, wherein wᵢⱼ are the coefficients of the interaction terms between xᵢ and xⱼ in the quadratic term. Specifically, in real-world problems, most problems involve constraints. These constrains can be categorized into equality constraints and inequality constraints.

Generally, the equality constraints are expressed as:

$$n equality form : {\sum }_{i} {a}_{i}^{( j )} {x}_{i} = {b}^{( j )} ,$$

for j=1, . . . n, wherein

$${a}_{i}^{( j )}$$

is the coefficient in the j-th constraint, representing the weight or coefficient of variable xᵢ in the j-th equation, b^{(j)} is the constant term or the target value of the j-th equality. The equality constraints can be directly converted into a quadratic penalty term

$$n equality constraints binary form : {( {\sum }_{i} {a}_{i}^{( j )} {x}_{i} - {b}^{( j )} )}^{2} ,$$

for j=1, . . . , n. The inequality constrains can be expressed as:

$$m inequality constraints : {\sum }_{i}^{n} {c}_{i}^{( j )} {x}_{i} \leq {d}^{( j )} ,$$

for j=1, . . . , m, wherein

$${c}_{i}^{( j )}$$

is the coefficient in the j-th inequality constraint, representing the weight or coefficient of the variable xᵢ in the j-th inequality, and d^{(j)} is the coefficient in the j-th inequality constraint. It is necessary to add slack variables into the inequality constrains to convert the inequality constrains into a quadratic penalty term

$$m inequality constraints binary form : {( {\sum }_{i}^{n} {c}_{i}^{( j )} {x}_{i} - {d}^{( j )} + {\sum }_{k}^{{n}^{( j )}} {e}_{k}^{( j )} {z}_{k}^{( j )} )}^{2} ,$$

for j=1, . . . , m, wherein

$${e}_{k}^{( j )}$$

determines the influence or weight of the variable

$${z}_{k}^{( j )}$$

in the inequality, and

$${z}_{k}^{( j )}$$

is the slack variable.

After the quadratic penalty term is transformed into the QUBO form, the quantum annealer can be used to solve it. After the aforementioned quadratic penalty term is transformed into the QUBO form, the formed QUBO form is expressed as:

$$f ( x , z ) = {\sum }_{ij} {w}_{ij} {x}_{i} {x}_{j} + {\sum }_{j}^{n} {{λ}_{j} ( {\sum }_{i} {a}_{i}^{( j )} {x}_{i} - {b}^{( j )} )}^{2} + {\sum }_{j}^{m} {{ρ}_{j} ( {\sum }_{i} {c}_{i}^{( j )} {x}_{i} - {d}^{( j )} + {\sum }_{k}^{{n}^{( j )}} {e}_{k}^{( j )} {z}_{k}^{( j )} )}^{2} ,$$

wherein λⱼ and ρⱼ are penalty coefficients.

$${z}_{k}^{( j )}$$

is a slack variable and is also a binary variable. Consequently, when solving the problem, the quantum bits in the quantum annealer must be used. According to the aforementioned formula, the number of slack variables introduced in the inequalities will increase linearly with the number of inequalities m and the size of d^{(j)}. Since the limited number of qubits in the quantum annealer are largely occupied, the quality of the solution is adversely affected and the size of the processible problem is restricted.

Therefore, there is a need of providing a computing method for obtaining slack variables in an objective function in order to overcome the drawbacks of the conventional technologies.

### SUMMARY OF THE INVENTION

The present invention provides a computing method for obtaining slack variables in an objective function. The computing method is applicable to a quantum computing device. This computing method utilizes the framework of Reinforcement Learning (RL) to assist in finding the slack variables solution in the objective function in the QUBO form (Quadratic Unconstrained Binary Optimization form). Consequently, the number of qubits when using quantum annealers or the memory burden when using digital annealers will be reduced. Consequently, the ability to solve complex problems is enhanced, and the accuracy of the obtained solutions is improved.

In accordance with an aspect of the present invention, a computing method for obtaining slack variables in an objective function being used in a quantum computing device is provided, the computing method includes steps of:
(S1) providing a processor, wherein the processor has a first function; (S2) initializing the first function, and setting an episode value in the processor; (S3) providing a state vector, and initializing the state vector by the processor; (S4) inputting the state vector into the first function, wherein according to the state vector and a policy, the processor generates an action vector, and the first function has a maximum value; (S5) converting the action vector into a quadratic unconstrained binary optimization form, performing an annealing process in an annealer to generate a binary variables solution and an energy value, and calculating a reward value according to the energy value; (S6) inputting the binary variables solution into the state vector by the processor; (S7) updating the first function according to a Q-Learning algorithm; (S8) the processor determining whether a number of consecutive occurrences of a same state vector is higher than a preset value, wherein when a determining condition is satisfied, the processor increments the episode value by one to indicate completion of an episode, and then a step (S9) is performed, wherein when the determining condition is not satisfied, the steps (S4) through (S7) are performed again; (S9) the processor determining whether the episode value reaches an upper limit, wherein when a determining condition is satisfied, a step (S10) is performed, wherein when the determining condition is not satisfied, the step (S3) is performed again; and (10) the processor selecting the episode with the lowest energy value from all episodes and choosing the first function at an end of the episode, wherein according to the selected first function and the state vector of an objective function in the quadratic unconstrained binary optimization form, the action vector that minimizes a final value of the energy value under the state vector is obtained, and the action vector is a slack variable.

### BRIEF DESCRIPTION OF THE DRAWINGS

The above contents of the present disclosure will become more readily apparent to those ordinarily skilled in the art after reviewing the following detailed description and accompanying drawings, in which:

FIGS. 1A and 1B are flowcharts illustrating a computing method for obtaining slack variables in an objective function; and

FIG. 2 is a schematic diagram illustrating the architecture of a processor and an annealer.

### DETAILED DESCRIPTION OF THE PREFERRED EMBODIMENT

The present invention will now be described more specifically with reference to the following embodiments. It is noted that the following descriptions of the preferred embodiments of the present invention are presented herein for purpose of illustration and description only. It is not intended to be exhaustive or to be limited to the precise from disclosed.

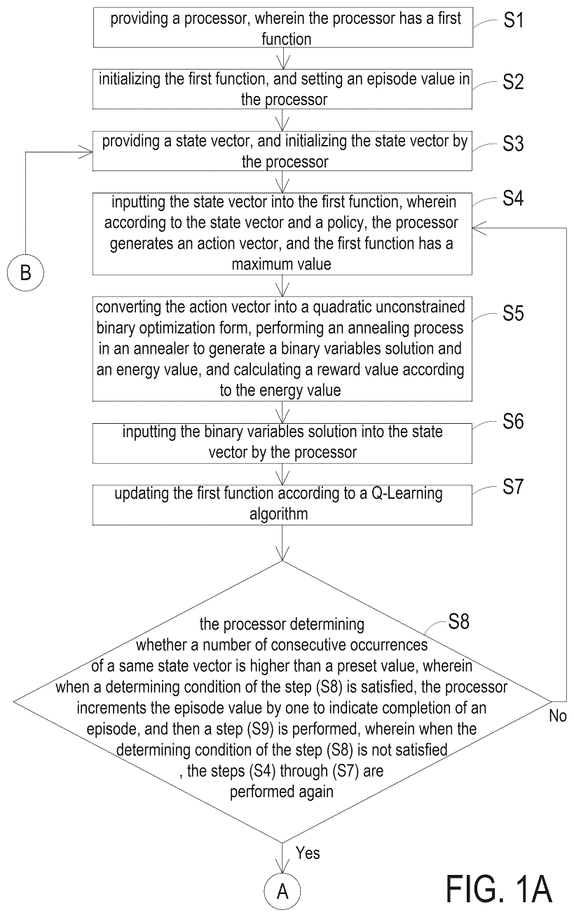

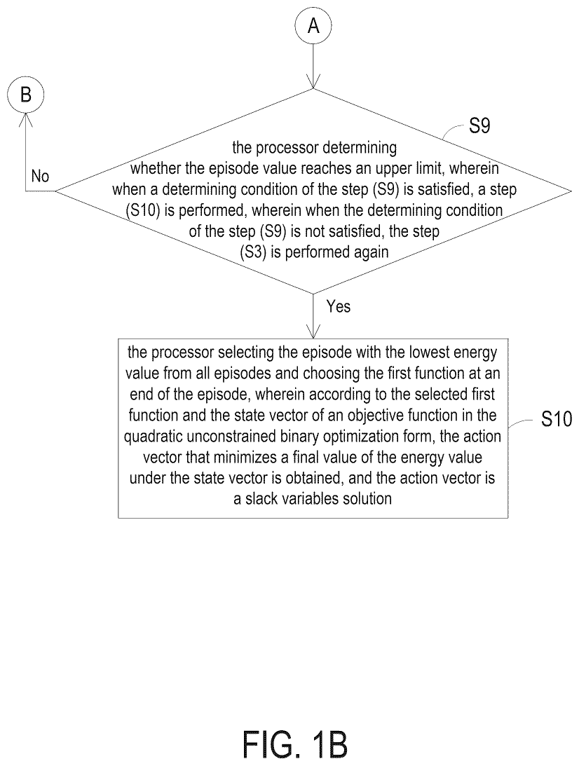

FIGS. 1A and 1B are flowcharts illustrating a computing method for obtaining slack variables in an objective function. The present invention uses the framework of Reinforcement Learning (RL) to assist in finding the slack variables solution in the QUBO form (Quadratic Unconstrained Binary Optimization form) of a problem.

In the framework of Reinforcement Learning (RL), there are five key elements: Agent, State, Action, Reward, and Environment. The agent is the decision-making entity. The agent selects the actions at each time step according to the observed state of the environment. The environment is where the agent operates, determining the state transitions and the rewards given after each action. The environment reacts to the agent's actions, influencing the agent's subsequent observations and behaviors. The state refers to the information about the environment that the agent observes, reflecting the situation agent is in a specific point and serving as the basis for the agent's decision-making. The action is the decision or move made by the agent in each state. The action affects the environment and determines the next state and feedback. The reward is the feedback provided by the environment after the agent performs a certain action. This feedback serves as a reward, which the agent uses to evaluate the quality of its actions and gradually learns to choose actions that maximize long-term rewards.

After multiple interactions with the environment, the agent learns how to maximize the final cumulative reward through its actions. In other words, the agent needs to find a strategy that enables it to obtain the maximum total reward from the environment over the long term.

For example, in the framework of Reinforcement Learning (RL), the agent is implemented through a neural network. The state and action are represented as vectors, and the reward is a scalar. The entire learning process involves the agent repeatedly interacting with the environment and adjusting its strategy according to the changes of the environment, with the goal of maximizing the cumulative reward.

At each time step t, the agent makes decisions based on the current state vector sₜ of the environment. The state vector sₜ represents the information about the environment at time step t, and this state vector sₜ is input into the agent's neural network as the input data. After the neural network receives the current state vector sₜ, an action vector aₜ is generated, the action vector aₜ represents the agent's response to the current environment.

After the agent performs the action vector aₜ, the environment changes according to this action vector aₜ and proceeds to the next time step t+1. This change affects the state of the environment and generates a new state vector sₜ₊₁.

At time step t+1, the environment provides a corresponding reward r. The reward r represents the feedback after the agent performs the action vector aₜ.

The neural network optimizes the strategy according to the reward r obtained at each time step. The agent adjusts the weights of the neural network. Consequently, the agent can select actions in the future that are more likely to generate higher rewards.

The above process is repeated iteratively, meaning that each time the agent executes an action, the environment provides a reward, and the neural network learns according to the rewards. Eventually, the agent will learn how to select actions that maximize the overall reward, enabling the agent to make optimal decisions in the given environment.

In accordance with present invention, the computing method for obtaining slack variables in an objective function involves using the Q-Learning algorithm for training to optimize a function. This function assists in finding the slack variables solution in the QUBO form of a problem.

For example, when dealing with the objective function of a problem, the binary variables in the objective function represent the state vectors. By applying the function obtained through training with the Q-Learning algorithm in reinforcement learning, these state vectors can be input into the function to generate action vectors. These action vectors are the slack variables solution in the QUBO form of the problem. Consequently, using reinforcement learning to find the slack variables solutions can reduce the number of qubits required when using a quantum annealer or reduce the memory burden when using a digital annealer. Under this circumstance, the ability to solve complex problems is enhanced, and the accuracy of the obtained solutions is improved.

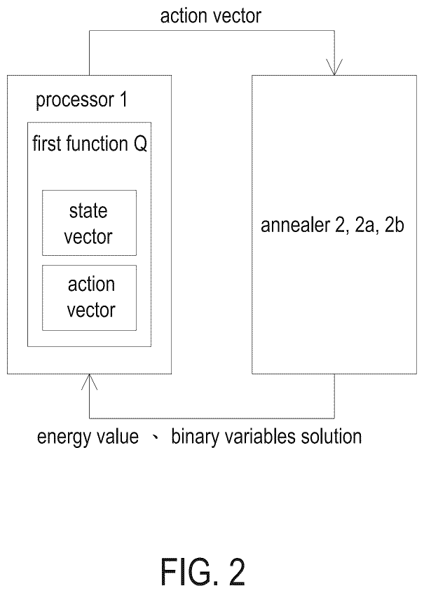

Please refer to FIGS. 1A, 1B and 2. FIGS. 1A and 1B are flowcharts illustrating a computing method for obtaining slack variables in an objective function, and FIG. 2 is a schematic diagram illustrating the architecture of a processor and an annealer. In this embodiment, the computing method for obtaining slack variables in an objective function is used in a quantum computing device. The computing method includes the following steps S1˜S10.

Firstly, in the step S1, a processor 1 is provided, wherein the processor 1 has a first function Q. Then, in the step S2, the first function Q is initialized, and an episode value is set in the processor 1. After this step, an episode of the reinforcement learning is started.

Then, in the step S3, a state vector is provided, and the state vector is initialized by the processor. In the step S4, the state vector is inputted into the first function Q. Furthermore, according to the state vector and a policy, the processor 1 generates an action vector, and the first function has a maximum value.

In an embodiment, the first function Q in the step S2 is an action-value function Q(s, a). The action-value function Q(s, a) is the agent of the reinforcement learning, wherein s represents the binary variables xᵢ in the objective function of the problem (i.e., the state vector sₜ in the step S3), a represents the action vector aₜ, which is the solution for the slack variables zᵢ in the QUBO form of the problem, and t is the time step.

In an embodiment, the action-value function Q(s, a) is implemented through a neural network.

In an embodiment, the policy in the step S4 is a greedy policy.

Then, in the step S5, the action vector is converted into a QUBO form (quadratic unconstrained binary optimization form), and an annealing process is performed in an annealer 2 to generate a binary variables solution and an energy value. According to the energy value, a reward value is calculated.

In an embodiment, the annealer 2 is a quantum annealer 2a or a digital annealer 2b. In case that the annealer 2 is a quantum annealer 2a, the annealing process is a quantum annealing process. In case that the annealer 2 is a digital annealer 2b, the annealing process is a simulated annealing process.

In an embodiment, in the step S5, the reward value is calculated according to a formula: r=e^{-E}, wherein r is the reward value, e is a mathematical constant, and E is the energy value.

Then, in the step S6, the binary variables solution is inputted into the state vector by the processor.

Then, in the step S7, the first function is updated according to a Q-Learning algorithm.

In an embodiment, in the Q-Learning algorithm in the step S7, the first function Q is updated according to a Bellman equation.

For example, in the step S7 of the Q-Learning algorithm, the reward r, the state vector s′ of the next time step (corresponding to the state vector obtained in step S6), and the possible actions a′ are used in conjunction with the Bellman equation. Under this circumstance, the formula r+γ·max_{a′}Q(s′, a′) is generated. In this formula, r is the current reward, representing the reward obtained after performing an action at the current time step, γ is the discount factor indicating the present value of future rewards, max_{a′} is the maximum action representing the selection of the action a′ from all possible actions that results in the highest value of the function Q(s′, a′), and Q(s′, a′) represents the expected cumulative reward for choosing the action a′ in the state s′. In other words, max_{a′}Q(s′, a′) represents the highest expected reward that can be obtained in the next time step s′ by selecting the optimal action a′.

Then, according to the formula r+γ·max_{a′}Q(s′, a′), the action-value function Q(s, a) is updated. Consequently, the update formula of Q(s, a) is expressed as: Q(s, a)←Q(s, a)+α[r+γ·max_{a′}Q(s′, a′)−Q(s, a)], wherein α represents the learning rate. This formula is used to update Q(s, a), helping the agent learn to select the optimal action vector for each state vector.

Then, in the step S8, the processor determines whether a number of consecutive occurrences of a same state vector is higher than a preset value. If the determining condition of the step S8 is satisfied, the processor increments the episode value by one to indicate completion of an episode, and then the step S9 is performed. If the determining condition of the step S8 is not satisfied, the steps S4 through S7 are performed again.

In an embodiment, in the step S8, the processor 1 determines whether the same state vector is generated consecutively. If the same state vector continues to be generated, it indicates that the first function Q may have converged. Consequently, the current episode of training can be concluded. Thus, reaching the preset value of occurrences signifies that the first function Q may have converged. In an embodiment, the preset value is 10. It is noted that the number of the preset value can be modified according to the practical requirements.

In the step S9, the processor 1 determines whether the episode value reaches an upper limit. If the determines condition of the step S9 is satisfied, a step S10 is performed. If the determining condition of the step S9 is not satisfied, the processor 1 performs the step S3 again. In an embodiment, the episode value is used to decide how many episodes of training will be conducted.

In the step S10, the processor selects the episode with the lowest energy value from all episodes and choosing the first function Q at an end of the episode. According to the selected first function and the state vector of an objective function in the quadratic unconstrained binary optimization form, the action vector that minimizes a final value of the energy value under the state vector is obtained, and the action vector is a slack variables solution.

In an embodiment, the processor 1 selects the episode with the lowest energy value from all episodes, which indicates that the first function Q from that episode can assist in finding the optimal solution for the slack variables solution. In other words, the agent learns how to identify the most suitable slack variables solution, allowing it to simultaneously satisfy the constraints of the optimization problem and optimize the objective function. After the binary variables of the objective function are input as state vectors into the first function Q, the first function Q helps select the most appropriate slack variables solution for the objective function. As a result, the slack variables solution can ensure that the constraints of the objective function are satisfied. The slack variables solution identified by this algorithm, compared to other solutions that also meet the constraints, may enable the annealer to find a binary variables solution with a lower energy, which can be applied in a quantum computing device.

From the above descriptions, the present invention provides a computing method for obtaining slack variables solution in an objective function, which is applied to a quantum computing device. Through the use of the reinforcement learning method, a first function is obtained. Through the first function, the slack variables of the problem's objective function in the QUBO form are found. Consequently, the objective function in the QUBO form is optimized to be use for quantum annealers or digital annealers. Since the number of variables in the objective function is significantly reduced, the complexity of the problem is directly reduced. Furthermore, the annealer has the capability to handle more complex problems and find a high-quality solution more efficiently and accurately. Consequently, the purpose of obtaining the optimal value of the objective function can be achieved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A computing method for obtaining slack variables in an objective function being used in a quantum computing device, the computing method comprising steps of:
(S1) providing a processor, wherein the processor has a first function;
(S2) initializing the first function, and setting an episode value in the processor;
(S3) providing a state vector, and initializing the state vector by the processor;
(S4) inputting the state vector into the first function, wherein according to the state vector and a policy, the processor generates an action vector, and the first function has a maximum value;
(S5) converting the action vector into a quadratic unconstrained binary optimization form, performing an annealing process in an annealer to generate a binary variables solution and an energy value, and calculating a reward value according to the energy value;
(S6) inputting the binary variables solution into the state vector by the processor;
(S7) updating the first function according to a Q-Learning algorithm;
(S8) the processor determining whether a number of consecutive occurrences of a same state vector is higher than a preset value, wherein when a determining condition of the step (S8) is satisfied, the processor increments the episode value by one to indicate completion of an episode, and then a step (S9) is performed, wherein when the determining condition of the step (S8) is not satisfied, the steps (S4) through (S7) are performed again;
(S9) the processor determining whether the episode value reaches an upper limit, wherein when a determining condition of the step (S9) is satisfied, a step (S10) is performed, wherein when the determining condition of the step (S9) is not satisfied, the step (S3) is performed again; and
(S10) the processor selecting the episode with the lowest energy value from all episodes and choosing the first function at an end of the episode, wherein according to the selected first function and the state vector of an objective function in the quadratic unconstrained binary optimization form, the action vector that minimizes a final value of the energy value under the state vector is obtained, and the action vector is a slack variables solution.

2. The computing method according to claim 1, wherein the first function is an action-value function.

3. The computing method according to claim 2, wherein the action-value function is implemented through a neural network.

4. The computing method according to claim 1, wherein in the step (S4), the policy is a greedy policy.

5. The computing method according to claim 1, wherein in the step (S5), the annealer is a quantum annealer, and the annealing process is a quantum annealing process.

6. The computing method according to claim 1, wherein in the step (S5), the annealer is a digital annealer, and the annealing process is a simulated annealing process.

7. The computing method according to claim 1, wherein in the step (S5), the reward value is calculated according to a formula: r=e^{-E}, wherein r is the reward value, e is a mathematical constant, and E is the energy value.

8. The computing method according to claim 1, wherein in the Q-Learning algorithm in the step (S7), the first function is updated according to a Bellman equation.

9. The computing method according to claim 1, wherein in the step (S8), the preset value is 10.
